(19) United States
(12) Patent Application Publication
(10) Pub. No.: US 2016/0105801 A1
(43) Pub. Date: Apr. 14, 2016

(54) GEO-BASED ANALYSIS FOR DETECTING ABNORMAL LOGINS

(71) Applicant: Microsoft Corporation, Redmond, WA (US)

(72) Inventors: Craig Henry Wittenberg, Clyde Hill, WA (US); Gil Lapid Shafriri, Redmond, WA (US); Daniel L. Mace, Bellevue, WA (US); Himanshu Chandola, Bellevue, WA (US)

(21) Appl. No.: 14/510,818

(22) Filed: Oct. 9, 2014

(51) Int. Cl. H04W 12/12; H04W 12/06; H04W 4/02

(52) U.S. Cl. CPC H04W 12/12; H04W 4/021; H04W 12/06; H04W 4/028

(57) ABSTRACT

Embodiments are directed to establishing an acceptability model to determine the acceptability of a communication originating from a specified location and to evaluating the acceptability of a received communication. In one scenario, a computer system accesses a communication history for an electronic device, at least one similar user's communication history and similar locations based on geographic topology data, where the communication history includes at least one previous communication between the electronic device and a computer system. The computer system accesses an updateable listing of locations based on the geographic topology data from which communications may be received from the electronic device. The computer system then generates an acceptability model configured to provide a reachability score that indicates the acceptability of subsequent communications from the electronic device based on the communication history, the similar user's communication history and the geographic topology data.

### BACKGROUND

Smart phones have become ubiquitous the world over, allowing users to perform many different types of functionality on a single device. For instance, smart phones allow users to send and read email, interact with social networks, view and edit photographs and videos, access applications, browse the internet and perform many other functions, including making phone calls. In some cases, smart phones applications or services prompt users to log in to access certain portions of data. This data may be personal or work-related, and may include sensitive information. This sensitive information often becomes a target for illegitimate, unauthorized users. As such, login attempts by illegitimate users are to be identified and prevented.

### BRIEF SUMMARY

Embodiments described herein are directed to establishing an acceptability model to determine the acceptability of a communication originating from a specified location and to evaluating the acceptability of a received communication. In one embodiment, a computer system accesses a communication history for an electronic device, a similar user's communication history and similar locations based on geographic topology data, where the communication history includes at least one previous communication between the electronic device and a computer system. The computer system accesses an updateable listing of locations based on the geographic topology data from which communications may be received from the electronic device. The computer system then generates an acceptability model configured to provide an acceptability score that indicates the acceptability of the subsequent communication from the electronic device based on the communication history and other communication histories for electronic devices similar to the electronic device.

In another embodiment, a computer system evaluates the acceptability of a received communication. The computer system receives a communication from a user's electronic device at a specified time. The communication includes identification information that identifies the electronic device, which is associated with the user and the time of communication. The computer system accesses location information that identifies the current location of the electronic device and accesses a generated reachability score indicating the probability that the electronic device's current location was reachable based on the location of the electronic device's last communication. The computer system compares the location from which the communication was received to the probability indicated by the reachability score to determine whether the communication's location is acceptable and, if the probability indicated by the comparison is below a threshold level, the computer system indicates that the communication is suspicious.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be apparent to one of ordinary skill in the art from the description, or may be learned by the practice of the teachings herein. Features and advantages of embodiments described herein may be realized and obtained by means of the instruments and combinations particularly pointed out in the appended claims. Features of the embodiments described herein will become more fully apparent from the following description and appended claims.

### BRIEF DESCRIPTION OF THE DRAWINGS

To further clarify the above and other features of the embodiments described herein, a more particular description will be rendered by reference to the appended drawings. It is appreciated that these drawings depict only examples of the embodiments described herein and are therefore not to be considered limiting of its scope. The embodiments will be described and explained with additional specificity and detail through the use of the accompanying drawings in which:

FIG. 1 illustrates a computer architecture in which embodiments described herein may operate including establishing an acceptability model to determine the acceptability of a communication originating from a specified location.

FIG. 2 illustrates a flowchart of an example method for establishing an acceptability model to determine the acceptability of a communication originating from a specified location.

FIG. 3 illustrates a flowchart of an example method for evaluating the acceptability of a received communication.

FIG. 4 illustrates an embodiment in which communications are mapped to a geographic topological map.

FIG. 5 illustrates an embodiment of a map of predicted reachability scores.

FIG. 6 illustrates an embodiment where anchor points are determined and areas of likely travel are identified.

### DETAILED DESCRIPTION

Embodiments described herein are directed to establishing an acceptability model to determine the acceptability of a communication originating from a specified location and to evaluating the acceptability of a received communication. In one embodiment, a computer system accesses a communication history for an electronic device, a similar user's communication history and similar locations based on geographic topology data, where the communication history includes at least one previous communication between the electronic device and a computer system. The computer system accesses an updateable listing of locations based on the geographic topology data from which communications may be received from the electronic device. The computer system then generates an acceptability model configured to provide an acceptability score that indicates the acceptability of the subsequent communication from the electronic device based on the communication history and other communication histories for electronic devices similar to the electronic device.

In another embodiment, a computer system evaluates the acceptability of a received communication. The computer system receives a communication from a user's electronic device at a specified time. The communication includes identification information that identifies the electronic device, which is associated with the user and the time of communication. The computer system accesses location information that identifies the current location of the electronic device and accesses a generated reachability score indicating the probability that the electronic device's current location was reachable based on the location of the electronic device's last communication. The computer system compares the location from which the communication was received to the probability indicated by the reachability score to determine whether the communication's location is acceptable and, if the probability indicated by the comparison is below a threshold level, the computer system indicates that the communication is suspicious.

The following discussion now refers to a number of methods and method acts that may be performed. It should be noted, that although the method acts may be discussed in a certain order or illustrated in a flow chart as occurring in a particular order, no particular ordering is necessarily required unless specifically stated, or required because an act is dependent on another act being completed prior to the act being performed.

Embodiments described herein may implement various types of computing systems. These computing systems are now increasingly taking a wide variety of forms. Computing systems may, for example, be handheld devices, appliances, laptop computers, desktop computers, mainframes, distributed computing systems, or even devices that have not conventionally been considered a computing system. In this description and in the claims, the term “computing system” is defined broadly as including any device or system (or combination thereof) that includes at least one physical and tangible processor, and a physical and tangible memory capable of having thereon computer-executable instructions that may be executed by the processor. A computing system may be distributed over a network environment and may include multiple constituent computing systems.

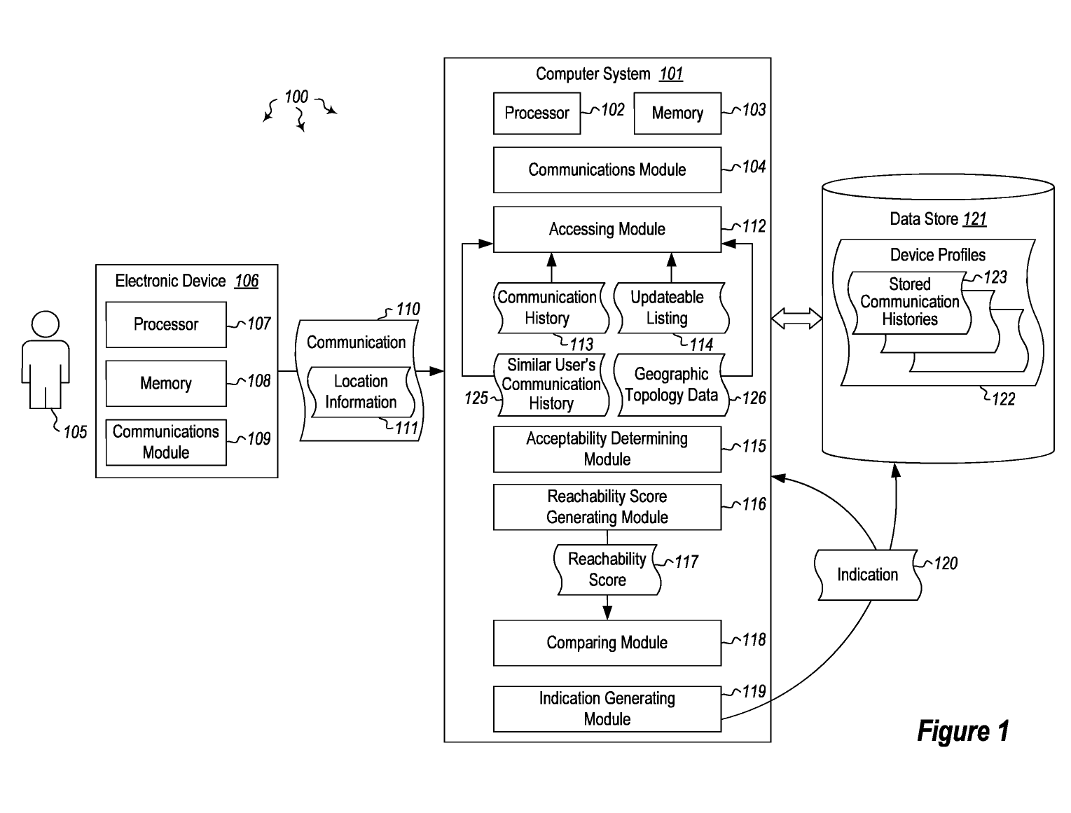

As illustrated in FIG. 1, a computing system 101 typically includes at least one processing unit 102 and memory 103. The memory 103 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

As used herein, the term “executable module” or “executable component” can refer to software objects, routings, or methods that may be executed on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. For example, such computer-executable instructions may be embodied on one or more computer-readable media that form a computer program product. An example of such an operation involves the manipulation of data. The computer-executable instructions (and the manipulated data) may be stored in the memory 103 of the computing system 101. Computing system 101 may also contain communication channels that allow the computing system 101 to communicate with other message processors over a wired or wireless network.

Embodiments described herein may comprise or utilize a special-purpose or general-purpose computer system that includes computer hardware, such as, for example, one or more processors and system memory, as discussed in greater detail below. The system memory may be included within the overall memory 103. The system memory may also be referred to as “main memory”, and includes memory locations that are addressable by the at least one processing unit 102 over a memory bus in which case the address location is asserted on the memory bus itself. System memory has been traditionally volatile, but the principles described herein also apply in circumstances in which the system memory is partially, or even fully, non-volatile.

Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, embodiments of the invention can comprise at least two distinctly different kinds of computer-readable media: computer storage media and transmission media.

Computer storage media are physical hardware storage media that store computer-executable instructions and/or data structures. Physical hardware storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the principles described herein may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

Still further, system architectures described herein can include a plurality of independent components that each contribute to the functionality of the system as a whole. This modularity allows for increased flexibility when approaching issues of platform scalability and, to this end, provides a variety of advantages. System complexity and growth can be managed more easily through the use of smaller-scale parts with limited functional scope. Platform fault tolerance is enhanced through the use of these loosely coupled modules. Individual components can be grown incrementally as business needs dictate. Modular development also translates to decreased time to market for new functionality. New functionality can be added or subtracted without impacting the core system.

FIG. 1 illustrates a computer architecture 100 in which at least one embodiment may be employed. Computer architecture 100 includes computer system 101. Computer system 101 may be any type of local or distributed computer system, including a cloud computing system. The computer system 101 includes modules for performing a variety of different functions. For instance, the communications module 104 may be configured to communicate with other computing systems. The computing module 104 may include any wired or wireless communication means that can receive and/or transmit data to or from other computing systems. The communications module 104 may be configured to interact with databases, mobile computing devices (such as mobile phones or tablets), embedded or other types of computing systems.

The communications module 104 may, for example, receive communication 110 from electronic device 106. The communication may include any type of data, and may indicate the current location of the device. The electronic device 106 may be any type of mobile or stationary device, including a smartphone, tablet, laptop or wearable device. The electronic device 106 may include hardware such as a processor 107 and associated memory 108. The electronic device 106 may also include a communications module 109 similar to that of computer system 101. In one embodiment, the user 105 may use the electronic device 106 to login to an account. For example, computer system 101 may be (or may be part of) a cloud computing system, and may be configured to host services. The communication 110 may thus include login information for the user including their login credentials. In such cases, the computer system 101 may be configured to determine whether the user is a legitimate user or is a malicious user. Various techniques for determining the legitimacy of a user are explained below.

One technique for determining the legitimacy or a user (e.g. 105) or of a given login attempt (perhaps from another device or application) includes a geo-based analysis of logins, where the analysis detects various kinds of abnormal behavior. For instance, each time a user logs into a service hosted on computer system 101, the service may capture a record of that login with information including the current time, internet protocol (IP) address, tenant or user identifier, portable unique identifier (PUID), and/or user agent string. The geographic location of a given login may be determined using a geographic IP address database that identifies general geographic areas for IP addresses. This geographic IP address database may be provided on premises, or may be a third party database. Geographic IP address databases, however, can only provide a very general indication of the user's location, and do not offer a great deal of precision.

Some users (e.g. 105) may have multiple electronic devices. Each of these electronic devices may be tracked in association with their corresponding user. Each device may be distinguished using a unique user agent string. When communications are received from that device (e.g. communication 110), the computer system 101 compares the received communication with previous communications to determine a risk score for the communication. Thus, in cases where the received communication 110 is a login attempt, the newly received login may be compared to a baseline model of prior logins to determine a risk score. The baseline model may include a representation of login patterns for each user, each tenant as a whole and patterns across all tenants. The baseline model may implement machine learning techniques to retrain itself (e.g. using feedback loops) to identify login patterns and anomalies. The baseline model may also be retrained manually by a user.

Logins to organizational accounts or other received communications (e.g. 110) may be recorded and saved in data store 121. Each device may have its own device profile 122 with a corresponding communication history 123. Similarly, the stored communication histories may be associated with a user, tenant or group of tenants, in addition to or as an alternative to associating the histories with a device profile. Indeed, in cases where a user has multiple devices, a communication history may be stored for each device and then associated with the user. When a communication is received, the IP address (or other identifier) may be translated into geographic location including latitude and longitude. Other information such as the owner of the IP address or address block may also be identified. In some cases, this location lookup may involve a query to a third party geo-IP database. Once the answer to the query is received, it is stored with the communication history 123 for the device. The IP address, geo location and other communication history information may be stored in the clear, may be hashed or may be encrypted.

In one embodiment, a system for scoring the legitimacy of received logins or other communications may include five parts: a feature extractor, a reachability model (i.e. a score for how likely a location is for a given user at the time the login occurs), runtime state maintained during the evaluation of the reachability model, domain knowledge encoded as a Markov chain to calculate transition probabilities and rules to handle special cases and do the final scoring, and runtime state for the evaluation of the Markov chain and rules.

This system may create representations of a user's travel patterns based on where the user has logged in in the past. Such logins may not, however, provide an accurate representation of the user's actual location—indeed, a user using a virtual private network (VPN) may appear to login from a certain location, while being located in completely different location. In such cases, the exact location of an individual may be difficult to decipher and can lead to false positives (e.g. consider a case where a user is using a cell phone in California, but also uses a work machine with a VPN connection to a company resource in Japan). Embodiments described herein consider a device-centric model, where each individual device has its own behavior model. This modelling approach significantly reduces the false positives of the model.

In some cases, devices will not have a communication history. For instance, a brand new device may come online for the first time, or may be associated with a given user for the first time. To address situations where a new device comes online for the first time online, a reachability score may be determined (e.g. by module 116 of computer system 101) for the device. The reachability score may indicate the likelihood that the device could be communicating from its current location, given its location in previous communications. Since travel speeds by car, airplane or walking are identifiable, it may be reasonable to specify some locations as being unreachable, or at least less likely to be reachable given previous communications. For instance, if a user logs in from a device in Los Angeles at 2:40 pm, and then logs in from Beijing, China at 3:15 pm, the reachability score for the China login is very low, whereas if the user logs in from Los Angeles at 2:40 pm and then logs in from San Francisco at 5:00 pm, the reachability score for the San Francisco login would be much higher.

In some embodiments described herein, the reachability score may implement graph based machine learning approaches, dimension reduction, and generalized linear models. Such modelling approaches define a similarity measure between individuals and then generate models that incorporate the login behavior of the user, but also some weighted representation of the login behavior of users that are similar to that user. Thus, similarity between users is to be determined in order to determine the reachability score.

In one embodiment, the similarity between a pair of users may be calculated as follows: for each unique individual location for a user, a frequency measure is calculated. The frequency measure is a relative measure of how often a location has been visited by the user. One calculated variable may include the number of unique weeks that a login was observed in the past X number of days (e.g. 45 days). Another calculated variable may include the number of unique days a user has logged in in the past X number of days (e.g. 45 days). The normalized frequency of an individual location is then determined, followed by the similarity between individuals which includes the symmetric distance between the two individuals, as well as the distance between two locations. The radial distance between two locations (based on longitude and latitude) is then compared to the domain that the IP address maps to in the geo-IP mapping.

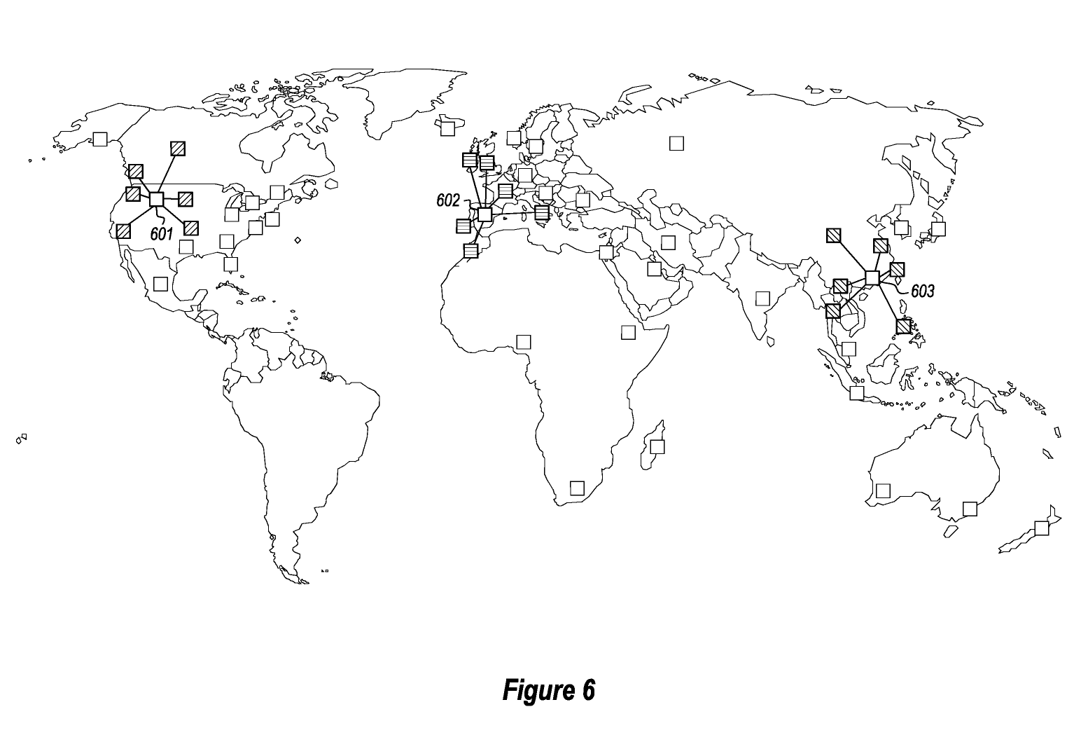

A graph based approach to detecting similarity between users is used. The graph based approach may involve methods such as random walk with restarts or spectral clustering (as generally shown in FIG. 6), as will be discussed further below. For each individual domain, pairwise distances are calculated between each user account and the other users' accounts. The random walk process normalizes the internal distances between individuals and computes the probability of walking between the two electronic device users. The reachability score (e.g. 117) is calculated by performing a random walk with restarts. For each user, a walk is initiated and run for one or more iterations. An aggregate location profile is built based on the users that were visited. Each random walk provides a set of visited locations. To transform this set into a list of possible new locations, the distance from every possible unique geo-IP location is calculated to this set. For efficiency reasons, a sparse set of locations may be pre-computed (in some cases this may involve around 2,000 calculations per walk set).

The output of the random walk can be interpreted as the acceptability of a new location based on the past behavior of an individual and the past behavior of users similar to themselves. As can be seen in Error! Reference source not found.6, the reachability score is capable of predicting sub-localizations across country boundaries. Empirical evidence has shown that an aggregate walk score of 80 (out of 1000 random walks), is representative of an appropriate visited location. This accounts for a minimum 8% observance in the walk chain, which is nearly equivalent to the 5% threshold set for outliers in standard anomaly detection methods.

While the random walk generates accurate profiles of individual behavior, the walk itself can be computational expensive as it requires several high cost calculations, most notably determining a certain number of nearest neighbors. Such calculations may involve hand-tuned hashing functions. An alternative to the full random walk approach is to implement a more compact prediction model to describe the expected login behavior for a user. This approach is described further below.

Embodiments described herein including building reachability locations rely on using a set of representative exemplar points or cluster centers to build a predictive model for user locations. By using a set of exemplar points and a generalized linear model, fast, efficient models may be built for predicting the reachability of a location. In one embodiment, method involves three steps: First, the random walk is run, generating a set of reachable locations for a subset of the data. The random walk is performed to generate a baseline set of training data for the generalized modelling approaches described in steps two and three. In the second step, a set of exemplar anchor points is determined from the data. Embodiments may use a scalable spectral clustering algorithm such as the Nystrom method. In the third step, the output from the random walk (the reachability values, 0-1000), is combined with a weighted representation of the anchor points as the feature space. (The anchor points may also be wrapped around a principal component analysis (PCA), which helps limit overfitting). The reachability calculation is then transformed into a generalized linear model problem: y=g(x), where g(x) is some non-linear transformation of the weighted distance calculations

In some cases, custom map reduce methods may be implemented. These allow code to be embedded into a machine learning tool to train the model. This input is then passed into a regression model (e.g. a fast rank regression model). Evaluation of locations can then be done by calculating the sparse anchor point representation, transforming using PCA, and then applying the sparse points to the regression model, providing a fast efficient evaluation of a geographical location.

Feature detection using fuzzy K-means clustering may be implemented in embodiments herein, as it has been shown to have high performance for machine learning problems, even outperforming newer methods such as restricted Boltzmann machines. Spectral hashing methods may also be used when detecting fuzzy k-mean centers for anchor or exemplar points. Representing the reachability scores as a generalized linear model calculation provides several benefits. First, the evaluation of a new location implements the calculation of the feature space of the model (distance to the anchor points), a lookup of the model parameters, and fast evaluation of the generalized linear model. Since the model doesn't require building a user specific model, the evaluation can be done rapidly on new users without retraining the underlying model (although new tenants may require retraining to identify tenant specific proxies). This fast calculation also allows a natural translation of these methods to a real time system, where logins can be evaluated as they arrive and decisions can be made to deal with outliers.

Another component in the model combines a Markov chain with a few rules to handle special cases. The resulting transition probabilities are divided into tritiles of risk: high, medium and low. Two special cases are the first login, which may simply be trusted to be correct, and static (non-stationary) devices. For each user, the computer system 101 maintains a list of devices and possible locations of the user. For each device, a communication history 123 is stored, indicating when it was last detected and when it last moved in location. Another variable per device may also be implemented which states whether a device is static or mobile according to calculated estimates. A static device is one whose location has not changed in the last X number of days (e.g. 15 days), weeks or other time period. At least in some embodiments, static devices do not figure into determining where a user is located and thus whether future logins make sense from a geographic point of view.

As the user uses their devices in normal, everyday types of use, the the system's confidence in its predictions may be different depending on the given location and the logins that took place up to that time. If this is modelled as a sequence of events, then the predictions at time (t+1) are dependent on where the user is at time (t). Thus, the estimates for the transitions would impact the predictions at time t+1 as well as be dependent on where the user was at time t. A model may be created for estimating the user's location with a first order Markov Chain. The states of the chain represent the possible locations for a user. The transition matrix is dynamic and is computed at each step in the chain, based on the timestamp and location of the logins.

For a given time step (i.e., each login), the speed of the transition to the location of the current login is evaluated and placed into one of three categories—Very High Speed, High Speed and Normal Speed. The location to which the transition is being made is similarly places into one of three categories—High reachability, Medium reachability and Low reachability. The transition probabilities for the transition to observed location may be computed by using these indices into a probabilities table (Table 1) below.

TABLE 1

| | Low | Med | High |
|---|---|---|---|
| | Reachability | Reachability | Reachability |
| Normal Speed | 0.5 | 0.7 | 1.0 |
| High Speed within cut off | 0.2 | 0.3 | 0.5 |
| Very High Speed | 0.05 | 0.1 | 0.2 |

The transition from a location at a time step to the same location in the next time step which is unobserved is then one minus the transition probability from this table. For locations that are the same as the observed location, the transition probability from the location in the previous time step is scored as “1” in order to have an effect similar to an absorbing state in a Markov Chain.

In some embodiments, making a classification may include the following steps: 1) If this is the first entry for a user, mark it as a normal login with the observed location as the only location with a probability of 1. 2) If the device is static (has not changed its location with Normal logins over a period of X days) then update the timestamp of the location in the location list and classify as normal. 3) Otherwise, compute the list of locations with their probabilities, as outlined above, for the time at which a login record is observed. 3a) If the probability of the observed location is less than the high risk threshold (0.2 currently), then score it high risk. 3b) If the probability is higher than high risk threshold (0.2) but lower than the threshold for normal logins (0.3), it is medium risk. 3c) Otherwise it is categorized as low risk. This approach has been shown to correctly handle sequences of interleaving logins from two different locations that were happening due to use of a proxy. This approach also correctly reflects the system's confidence in the user's current location.

Given an IP address, the system determines the “location” of the device that is appearing on the internet at that IP. The location information is, at the same, both too precise and not precise enough. It is too precise because a specific point on the earth is indicated which is rarely, if ever, the precise point of the person using the device. It is not precise enough because some locations are a just a point in the center of a country (e.g., lat. 38, long. −97 for the U.S.), and because some IP addresses are wireless aggregation points that cover many customers of a wireless company. The variable accuracy of the location is countered using a probabilistic estimation of a user's location. Some of the variation in IP address location is handled in the reachability score calculation. This is accomplished by treating locations within a geographic region to be similar. This approach allows the system to account for specific IP sub-block ranges that are unseen but are within a similar range of other IP sub-blocks.

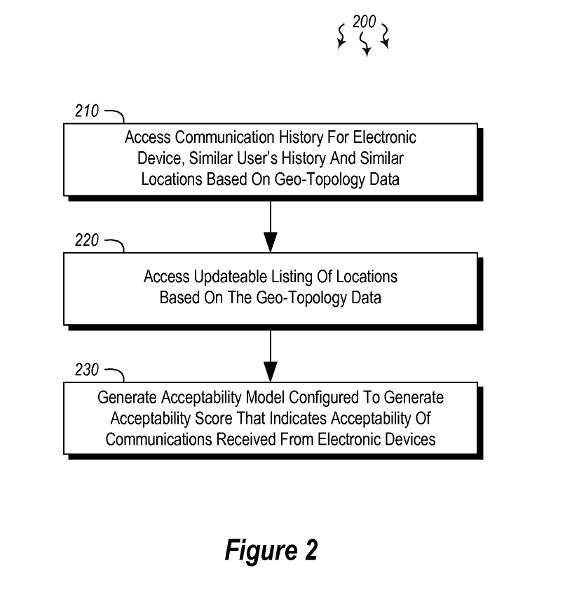

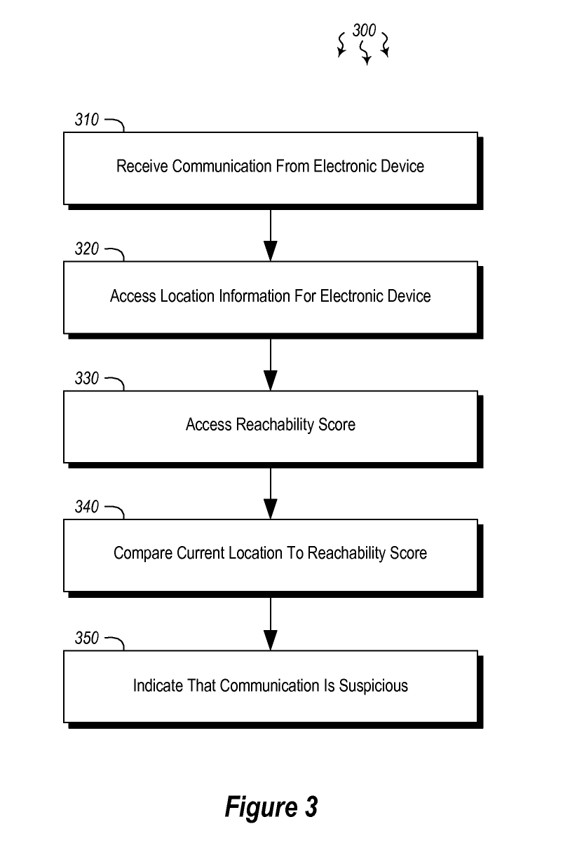

When calculating the final reachability score, this variable accuracy is handled by treating as the same any two “locations” that are within X number of miles of each other (e.g. 100 miles). This may also be performed for privacy reasons. Some embodiments may calculate a per-device location volatility to capture the difference between location movements that are more normal (e.g., going to different Wi-Fi hot spots) and those that are highly varying (e.g., a smartphone which moves into a new coverage area which causes a large shift in the “location” as determined by the IP address). These concepts will be explained further below with regard to methods 200 and 300 of FIGS. 2 and 3, respectively.

In view of the systems and architectures described above, methodologies that may be implemented in accordance with the disclosed subject matter will be better appreciated with reference to the flow charts of FIGS. 2 and 3. For purposes of simplicity of explanation, the methodologies are shown and described as a series of blocks. However, it should be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

FIG. 2 illustrates a flowchart of a method 200 for establishing an acceptability model to determine the acceptability of a communication originating from a specified location. The method 200 will now be described with frequent reference to the components and data of environment 100.

Method 200 includes accessing a communication history for an electronic device, at least one similar user's communication history and one or more similar locations based on geographic topology data, the communication history including at least one previous communication between the electronic device and a computer system (210). For example, accessing module 112 may access communication history 113, similar user's communication history 125 and various locations indicated in the geographic topology data 126. The communication history 113 may be one of the stored communication histories 123, or may be newly-generated. The communication history 113 may include one or more previous communications between electronic device 106 and computer system 101. The communications (e.g. 110) may include pings, heartbeat packets, messages, login attempts, application access requests, or other electronic communications. Thus, although embodiments described herein focus on login attempts, many other types of communications may be used.

Each communication history may be stored as part of a device profile associated with an electronic device (e.g. 106). Each device profile may, in turn, be associated with a user (e.g. 105). As will be explained below, the acceptability of a received communication may be determined according to information stored in the device profile including the device's communication history. The acceptability of a received communication may further be determined based on the similar user's communication history 125. As outlined above, this involves determining which users (i.e. which electronic devices) exhibit similar behavior. For instance, the users may have the same carrier, may log in to similar locations, may pass heartbeat packets between the same cell towers or may have other similar travel routines or destinations. The acceptability of a received communication may still further be based on geographic topology data 126 which may, for instance, indicate the location of cell towers or other places of accessing a wireless network.

Method 200 further includes accessing an updateable listing of locations based on the geographic topology data from which communications may be received from the electronic device (220). For example, the accessing module 112 may access updateable listing 114 which includes an updateable listing of locations around the world from which communications may be received from the electronic device 106, and may further include geographic topology data 126. For instance, in cases where the electronic device 106 is a cellular phone, that phone may connect to the internet via one or more of a plurality of cell phone towers distributed geographically across the earth. The cell phone may then use the internet connection to connect to computer system 101 and attempt to log in to a hosted service (such as an email service). Each location at which a user may access the internet wirelessly may be identified and placed in the updateable listing of locations 114. These identified locations may also be mapped to a map showing the geographical location of each wireless access point.

The locations identified in the updateable listing of locations 114 may include not only geographic locations, but also logical locations. For example, the updateable listing of locations may include different internet access points within a building or within some other logically-defined area that doesn't necessarily correspond to a geographical area. For instance, on a geographical map, multiple logins from the same building would appear to be from the same geographic location; however, these logins may come from different floors or different parts of floors within the building. The updateable listing of locations may thus include those geographic or logical locations at which internet communications are accessible to the electronic device 106. When new locations come online, these may be added to the updateable listing 114.

In one embodiment, the locations of the updateable listing of locations are mapped onto a geographic topology model (i.e. geographic topology data 126). This geographic topology model may show the listed locations in their corresponding geographic positions. The geographic topology model may include nearby cities or towns, or may include locations of cell phone towers. Other embodiments of the geographic topology model may illustrate indications of carrier networks in a given geographic area. For instance, some carrier networks may be more prominent in some states or countries, while non-existent in other states or countries. In some cases, a graph-based statistical model may be used to search through the locations at which internet access is available to the electronic device 106. The graph-based statistical model may show locations where the user is more likely or less likely to access the internet, based on carrier coverage or based on the number of available cell phone towers.

Method 200 further includes generating an acceptability model configured to provide a reachability score that indicates the acceptability of subsequent communications from the electronic device based on the communication history, the similar user's communication history and the geographic topology data (240). The acceptability determining module 115 of computer system 101 may determine based on the communication history for the device 113, based on communication histories for similar electronic devices 125 and based on the geographic topology data 126, whether a subsequent communication 110 is acceptable. The notion of “acceptability” here indicates that the communication (e.g. login attempt) is valid, or is at least likely valid. By comparing the device's current location to its past locations, the system may determine whether the user is likely to be in the current location, or whether a malicious user is posing as the user and trying to login as that user. By comparing the device's current location to its past locations, and by comparing it to similar device's communication histories, the system may determine with an even higher likelihood whether the communication is received from a legitimate user (i.e. the user 105 associated with electronic device 106).

As described above, a random walk may be used to identify electronic devices that have similar communication histories. For instance, users living in the same city that access the internet from the same locations day after day may have similar communication histories. The electronic devices associated with these similar communication histories may have sent communications from locations that the electronic device 106 has not. However, because the electronic devices share similar communication histories, those locations where the electronic device 106 has not yet been (or not yet accessed the internet) may be highly likely to be future login locations for the device 106. Thus, the computer system 101 may access the communication histories of similar devices, and may determine other locations from which subsequent communications from the electronic device are likely to occur (this may be the result of the random walk). The computer system 101 may then establish a machine learning model that determines the likelihood that the electronic device's communications are acceptable based on the electronic device's communication history and communication histories of similar electronic devices.

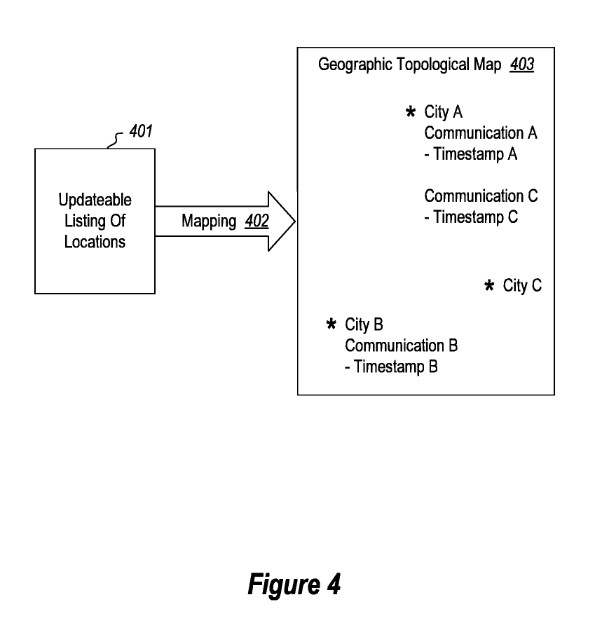

As shown in FIG. 4, a device's communications may be mapped to a geographic topological map 403. The mapping 402 may be produced from the updateable listing of locations 401, along with the location of the user's current communications 110 and previous locations noted in a communication history 113. For instance, in the geographic topological map, communication A is received near City A at timestamp A. Communication B is received near City B at timestamp B, while communication C is received near City A at timestamp C. The system described herein may look at the three communications (A, B & C) and determine whether it is feasible for an electronic device to send communications from those locations within the timeframe specified by the timestamps. If such travel is possible, then the likelihood is higher that the communication is legitimate. Similarly, if other similar users travel frequently from City A to City B and back, the communications may seem even more legitimate. If the communication histories for similar users also indicate that they often travel to City C, then when the user eventually travels to City C, the communication is highly likely to be legitimate, as the other users' communications have already shown. These communication histories may also be compared to a graph-based statistical acceptability model which outlines geographic or logical locations from which communications are more (or less) likely to be received.

Accordingly, as described herein, identifying electronic devices that have similar communication histories may include identifying electronic devices that are located within a specified geographic region (e.g. within the same city or surrounding region). In some cases, as shown in FIG. 6, anchor points may be established within a specified geographic region within a geographic topology model. The anchor points (e.g. 601, 602 and 603) may be implemented by a machine learning model to provide or generate a likelihood that the electronic device's communications are acceptable. For example, if the user's last communication was from anchor point 601, the shaded boxes may show locations from which legitimate communications are likely to be received. This number of shaded boxes may be reduced or enlarged based on the communication histories of other similar users/devices. These locations indicate potential travel points via car, airplane or some other mode of transportation, and may indicate places that the electronic device has been in the past.

The machine learning model may use a fast lookup (i.e. an approximate random walk) to determine locations from which subsequent communications from the electronic device are likely to occur. Such approximations may be used to determine the device's nearest neighbors, which device's use patterns are most similar, and which locations the user/device is most likely to visit. These locations may be local or global, and take communication timestamps into consideration. For instance, it may be highly likely that a user logs into an application in Los Angeles, and that the next login attempt occurs in New York City five hours later, or that a subsequent login attempt occurs in London eight hours later. Thus, the machine learning model may take travel times and communication timestamps into consideration when determining the acceptability of a communication.

In cases where the communication is an application login, the user's login history may be a part of the electronic device's device profile 122. The acceptability of the received login attempt may thus be determined according to information stored in the device profile, indicating whether previous login attempts have occurred from the user's current location, or whether the user is communicating from a location he or she is likely to be in.

Turning now to FIG. 3, a flowchart is illustrated of a method 300 for evaluating the acceptability of a received communication. The method 300 will now be described with frequent reference to the components and data of environment 100.

Method 300 includes receiving a communication from a user's electronic device at a specified time, the communication including identification information that identifies the electronic device, the electronic device being associated with the user and the time of communication (310). For example, communications module 104 of computer system 101 may receive communication 110 from the communications module 109 of electronic device 106. The communication 110 may include identification information such as an IP address or other identifier. The electronic device 106 is associated with user 105, and is further associated with the received communication and corresponding well as a timestamp. At least in some cases, communications from multiple different electronic devices are associated with a single user's profile. Alternatively stated, multiple device profiles 122 may be associated with a single user.

The method 300 further includes accessing location information that identifies the current location of the electronic device (320). This location information may be generated locally, or may be accessed from an electronic device location mapping service (such as a third party geo-IP database). Method 300 also includes accessing a generated reachability score 117 indicating the probability that the electronic device's current location was reachable based on the location of the electronic device's last communication (330). The reachability score 117 may be generated by reachability score generating module 116 of computer system 101, or may be generated by another computer system and merely accessed by computer system 101. The reachability score 117 indicates the likelihood that the location associated with the current communication 110 is reachable (i.e. acceptable) based on the location of a prior communication. Thus, if the two locations are close enough, or the time elapsed between communications is long enough, the communication has a higher likelihood of being legitimate.

The comparing module 118 of computer system 101 compares the location from which the communication 110 was received to the probability indicated by the reachability score to determine whether the communication's location is acceptable (340) and, if the probability indicated by the comparison is below a threshold level, the computer system 101 may indicate that the communication is suspicious (350). The reachability score 117 thus includes a calculation of the electronic device's travel speed, where the electronic device's travel speed is determined based on the geographical distance between the location of the last communication and the received communication and the amount of time between the communications. If the reachability score is above a specified threshold, the communication is marked as legitimate. If the reachability score 117 is below the threshold, the communication is marked as suspicious. The indication generating module 119 of computer system 101 may generate an indication 120 indicating the determined status of the communication. The indication 120 may remain internal to the computer system 101, or may be sent to other computing systems, or may be stored in the data store 121 as part of the device's communication history 123.

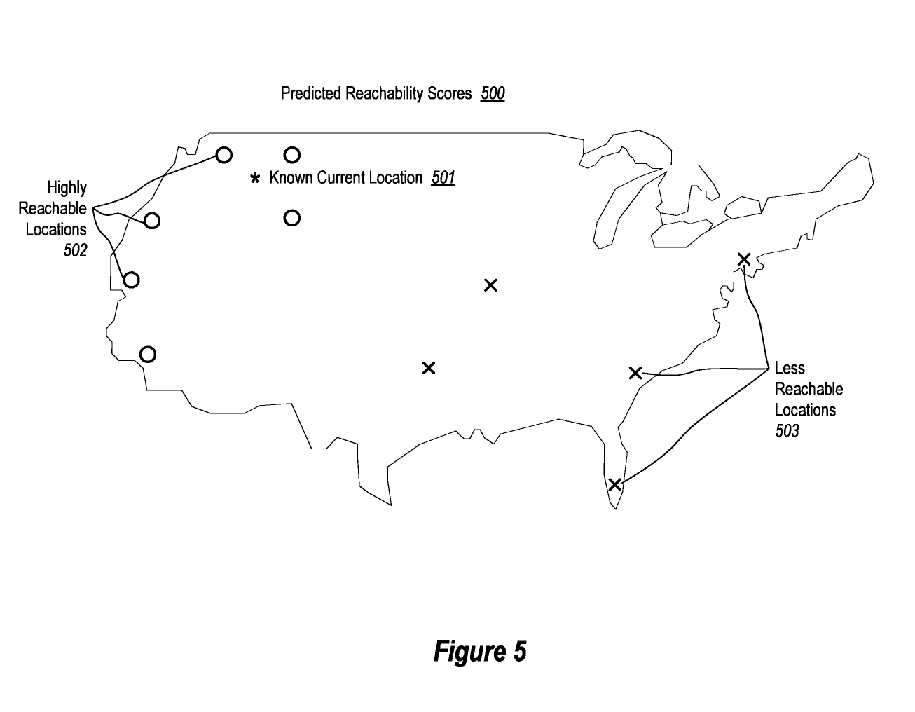

In some embodiments, a Markov chain may be used when generating the reachability score 117 to calculate the probability that the electronic device's current location was reachable based on the location of the electronic device's last communication. The Markov chain may provide an accurate indication of locations that are reachable based on the user's previous communications. As shown in FIG. 5, a map of predicted reachability scores 500 may be presented which shows locations that are highly reachable for the user/device (locations 502), and may also show other locations that are less reachable (locations 503). The reachability may be further based on the actions of similar users, and may broaden or narrow the range of acceptable locations.

Claims Support: In one embodiment, a computer system is described. The computer system may include processing means such as a hardware processor. The computer system may perform a computer-implemented method for establishing an acceptability model to determine the acceptability of a communication originating from a specified location, where the method includes the following: accessing a communication history 113 for an electronic device 106, at least one similar user's communication history 125 and one or more similar locations based on geographic topology data 126, the communication history including at least one previous communication 110 between the electronic device and a computer system 101, accessing an updateable listing of locations 114 based on the geographic topology data from which communications are receivable from the electronic device, and generating an acceptability model configured to provide a reachability score 117 that indicates the acceptability of subsequent communications received from the electronic device 106 based on the communication history, the similar user's communication history and the geographic topology data.

In some cases, the locations of the updateable listing of locations are mapped into a geographic topology model that shows the listed locations in their geographic positions. The geographic topology model further shows an indication of carrier networks in at least one geographic area. The method described above further includes identifying electronic devices that have similar communication histories, determining one or more locations from which subsequent communications from the electronic device are likely to occur, and establishing a machine learning model that is configured to provide the likelihood that the electronic device's communications are acceptable based on the electronic device's communication history and communication histories of similar electronic devices. Identifying electronic devices that have similar communication histories includes identifying electronic devices that are located within a specified geographic region.

In another embodiment, a computer system is provided. The computer system includes a processing means which performs a method for evaluating the acceptability of a received communication. The method includes the following: receiving a communication 110 from a user's electronic device 106 at a specified time, the communication including identification information that identifies the electronic device, the electronic device being associated with the user and the time of communication, accessing location information 111 that identifies the current location of the electronic device, accessing a generated reachability score 117 indicating the probability that the electronic device's current location was reachable based on the location of the electronic device's last communication, comparing the location from which the communication was received to the probability indicated by the reachability score 117 to determine whether the communication's location is acceptable, and if the probability indicated by the comparison is below a threshold level, indicating 119 that the communication is suspicious.

The reachability score includes a calculation of the electronic device's travel speed, the electronic device's travel speed being determined based on the geographical distance between the location of the last communication and the received communication and the amount of time between the communications. In some cases, a Markov chain is used when generating the reachability score to calculate the probability that the electronic device's current location was reachable based on the location of the electronic device's last communication.

In another embodiment, a computer system is provided which includes the following: one or more processors, an accessing module 112 configured to access a login history 113 for an electronic device 106, the login history including at least one previous login attempt between the electronic device and a computer system 101, the accessing module being further configured to access an updateable listing of locations 114 from which login attempts may be received from the electronic device, a receiving module 104 configured to receive at least one subsequent login attempt 110 from the electronic device, and an acceptability determining module 115 configured to determine the acceptability of the subsequent login attempt from the electronic device based on the login history and one or more login histories 123 for electronic devices similar to the electronic device.

In some cases, the login history is part of a device profile for the electronic device, and wherein the acceptability of the received login attempt is determined according to information stored in the device profile, the device profile being associated with a user. The locations in the updateable listing of locations include geographic locations or logical locations. The communication history is part of a device profile for the electronic device, and the acceptability of the received communication is determined according to information stored in the device profile. The updateable listing of locations includes those locations at which internet communications are accessible to the electronic device. One or more anchor points are established within the specified geographic region within the geographic topology model, the anchor points being implemented by the machine learning model in providing the likelihood that the electronic device's communications are acceptable. In some cases, a fast lookup of available locations is used to determine locations from which subsequent communications from the electronic device are likely to occur.

Accordingly, methods, systems and computer program products are provided which establish an acceptability model to determine the acceptability of a communication originating from a specified location. Moreover, methods, systems and computer program products are provided which evaluate the acceptability of a received communication.

The concepts and features described herein may be embodied in other specific forms without departing from their spirit or descriptive characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

We claim:

1. At a computer system including at least one processor, a computer-implemented method for establishing an acceptability model to determine the acceptability of a communication originating from a specified location, the method comprising:
accessing a communication history for an electronic device, at least one similar user's communication history and one or more similar locations based on geographic topology data, the communication history including at least one previous communication between the electronic device and a computer system;
accessing an updateable listing of locations based on the geographic topology data from which communications are receivable from the electronic device; and
generating an acceptability model configured to provide a reachability score that indicates the acceptability of subsequent communications received from the electronic device based on the communication history, the similar user's communication history and the geographic topology data.

2. The method of claim 1, wherein the locations in the updateable listing of locations comprise geographic locations or logical locations.

3. The method of claim 1, wherein the communication history is part of a device profile for the electronic device, and wherein the acceptability of the received communication is determined according to information stored in the device profile.

4. The method of claim 1, wherein the updateable listing of locations includes those locations at which internet communications are accessible to the electronic device.

5. The method of claim 4, wherein the locations of the updateable listing of locations are mapped into a geographic topology model that shows the listed locations in their geographic positions.

6. The method of claim 5, wherein the geographic topology model further shows an indication of carrier networks in at least one geographic area.

7. The method of claim 5, further comprising:
identifying electronic devices that have similar communication histories;
determining one or more locations from which subsequent communications from the electronic device are likely to occur; and
establishing a machine learning model that is configured to provide the likelihood that the electronic device's communications are acceptable based on the electronic device's communication history and communication histories of similar electronic devices.

8. The method of claim 7, wherein identifying electronic devices that have similar communication histories comprises identifying electronic devices that are located within a specified geographic region.

9. The method of claim 8, wherein one or more anchor points are established within the specified geographic region within the geographic topology model, the anchor points being implemented by the machine learning model in providing the likelihood that the electronic device's communications are acceptable.

10. The method of claim 7, wherein determining one or more locations from which subsequent communications from the electronic device are likely to occur comprises performing a fast lookup of available locations.

11. The method of claim 1, wherein at least one of the communications received from the electronic device comprises a login attempt that includes one or more login credentials.

12. The method of claim 1, wherein at least one of the communications received from the electronic device comprises an application access request.

13. At a computer system including at least one processor, a computer-implemented method for evaluating the acceptability of a received communication, the method comprising:
receiving a communication from a user's electronic device at a specified time, the communication including identification information that identifies the electronic device, the electronic device being associated with the user and the time of communication;
accessing location information that identifies the current location of the electronic device;
accessing a generated reachability score indicating the probability that the electronic device's current location was reachable based on the location of the electronic device's last communication;
comparing the location from which the communication was received to the probability indicated by the reachability score to determine whether the communication's location is acceptable; and
if the probability indicated by the comparison is below a threshold level, indicating that the communication is suspicious.

14. The method of claim 13, wherein the communication received from the electronic device includes login credentials and an internet protocol (IP) address for the electronic device.

15. The method of claim 13, wherein the accessed location information is received from an electronic device location mapping service.

16. The method of claim 13, wherein the reachability score includes a calculation of the electronic device's travel speed, the electronic device's travel speed being determined based on the geographical distance between the location of the last communication and the received communication and the amount of time between the communications.

17. The method of claim 13, wherein a Markov chain is used when generating the reachability score to calculate the probability that the electronic device's current location was reachable based on the location of the electronic device's last communication.

18. The method of claim 13, wherein communications from a plurality of electronic devices are associated with a single user's profile.

19. A computer system comprising the following:
one or more processors;
one or more computer-readable storage media having stored thereon computer-executable instructions that, when executed by the one or more processors, cause the computing system to perform a method for establishing an acceptability model to determine the acceptability of a communication originating from a specified location, the method comprising the following:
accessing a login history for an electronic device, the login history including at least one previous login attempt between the electronic device and a computer system;
accessing an updateable listing of locations from which login attempts may be received from the electronic device;
receiving at least one subsequent login attempt from the electronic device; and
determining the acceptability of the subsequent login attempt from the electronic device based on the login history and one or more login histories for electronic devices similar to the electronic device.

20. The computer system of claim 19, wherein the login history is part of a device profile for the electronic device, and wherein the acceptability of the received login attempt is determined according to information stored in the device profile, the device profile being associated with a user.
